(19) United States
(12) Patent Application Publication
(10) Pub. No.: US 2022/0289590 A1
(43) Pub. Date: Sep. 15, 2022

(54) LITHIUM TRANSITION METAL HALIDES

(71) Applicants: BASF SE, Ludwigshafen am Rhein (DE); University of Waterloo, Waterloo (CA)

(72) Inventors: Park Keonho, Waterloo (CA); Linda Nazar, Waterloo (CA); Jörn Kulisch, Ludwigshafen (DE); Xiaohan Wu, Ludwigshafen (DE)

(21) Appl. No.: 17/774,166

(22) PCT Filed: Nov. 5, 2020
(86) PCT No.: PCT/EP2020/081116

§ 371 Date: May 4, 2022

(30) Foreign Application Priority Data
Nov. 7, 2019 (EP) 19207728.7

(51) Int. Cl. C01G 25/04; H01M 10/0562; H01M 10/0525; C01G 51/00

(52) U.S. Cl. CPC C01G 25/04; H01M 10/0562; H01M 10/0525; C01G 51/42; H01M 2300/0068

(57) ABSTRACT

Described are a solid material which has ionic conductivity for lithium ions, a composite comprising said solid material and a cathode active material, a process for preparing said solid material, a solid structure selected from the group consisting of a cathode, an anode and a separator for an electrochemical cell comprising the solid material, and an electrochemical cell comprising such solid structure.

Described are a solid material which has ionic conductivity for lithium ions, a composite comprising said solid material and a cathode active material, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure.

Due to the wide-spread use of all-solid-state lithium batteries, there is an increasing demand for solid state electrolytes having a high conductivity for lithium ions. An important class of such solid electrolytes are lithium transition metal halides.

US 2019/0088995 A1 discloses a solid electrolyte material represented by the compositional formula:

Li_{6-3z}Y_{z}X₆

where 0<z<2 is satisfied; and X represents Cl or Br. According to US 2019/0088995 A1, these materials exhibit ionic conductivities in the range of from 0.2*10⁻⁴ S/cm to 7.1*10⁻⁴ S/cm at around room temperature.

WO 2019/135343 A1 discloses a solid electrolyte material comprising: Li; Y; at least one element selected from the group consisting of Mg, Ca, Sr, Ba, Zn, Sc, La, Sm, Bi, Zr, Hf, Nb and Ta; and at least one element selected from the group consisting of Cl, Br, and I, wherein the X-ray diffraction pattern for the solid electrolyte material obtained using Cu-Kα radiation as the X-ray source includes a plurality of peaks in the diffraction angle (20) range of 250 to 350 and at least one peak in the diffraction angle (20) range of 430 to 51°.

WO 2019/135345 A1 discloses a solid electrolyte material comprising: Li; Y; at least one element selected from the group consisting of Mg, Ca, Sr, Ba, Zn, Zr, Nb and Ta; and at least one element selected from the group consisting of Cl, Br, and I. An X-ray diffraction pattern for the solid electrolyte material obtained using Cu-Kα radiation as the X-ray source includes a peak in the diffraction angle (2θ) range of 30° to 33°, in the diffraction angle (2θ) range of 39° to 43°, and in the diffraction angle (2θ) range of 470 to 51°.

There is an ongoing need for solid lithium ion conductors which exhibit suitable ionic conductivity for application as solid electrolyte in all-solid state lithium batteries as well as electrochemical oxidative stability up to 4 V vs. Li/Li⁺ or more, preferably up to 4.5 V vs. Li/Li⁺, in order to enable application of cathode active materials having a redox potential of 4 V or more vs. Li/Li⁺ (cathode active material of the “4 V class”), so that a high cell voltage is obtainable.

It is an objective of the present disclosure to provide a solid material which may be used as a solid electrolyte for an electrochemical cell. More specifically, it is an object of the present disclosure to provide a solid material which may be used as a solid electrolyte for an electrochemical cell, wherein the cathode of said electrochemical cell comprises a cathode active material having a redox potential of 4 V or more vs. Li/Li⁺.

In addition, there is provided a composite comprising said solid material and a cathode active material, a process for preparing said solid material, a use of said solid material as a solid electrolyte for an electrochemical cell, a solid structure selected from the group consisting of a cathode, an anode and a separator for an electrochemical cell comprising the solid material, and an electrochemical cell comprising such solid structure wherein said solid structure comprises said solid material.

According to a first aspect, there is provided a solid material having a composition according to general formula (I)

Li_{3-n*x}M₁₋ₓM′ₓX_{y} (I)

wherein
M is one or more selected from the group consisting of Sc, In, Lu, La, Er, Y and Ho;
M′ is one or more selected from the group consisting of Ti, Zr, Hf, Nb and Ta;
X is one or more selected from the group consisting of halides and pseudohalides;
0.12≤x≤0.42;
5.8≤y≤6.2;
n is the difference between the valences of M′ and M.

Since M (as defined above) is three-valent, n is 1 if M′ is four-valent (as it is the case for Ti, Zr and Hf, and n is 2 if M′ is five-valent (as it is the case for Nb and V).

The composition according to general formula (I) may be considered as a lithium transition metal halide resp. as a lithium transition metal pseudohalide.

As used herein, the term “pseudohalides” (also referred to as “pseudohalogenides”) denotes monovalent anions, which resemble halide anions with regard to their chemistry, and therefore can replace halide anions in a chemical compound without substantially changing the properties of such compound. The term “pseudohalide ion” is known in the art, cf. the IUPAC Goldbook. Examples of pseudohalide anions are N₃⁻, SCN⁻, CN⁻, OCN⁻, BF₄⁻ and BH₄⁻. In pseudohalide-containing solid materials of general formula (I) the pseudohalide anion is preferably selected from the group consisting of BF₄⁻ and BH₄⁻.

In halide-containing solid materials of general formula (I) the halide is preferably selected from the group consisting of C, Br and I.

Surprisingly it has been found that solid materials having a composition according to general formula (I) as defined above may exhibit favorable lithium ion conductivity as well as electrochemical oxidation stability in contact with a cathode active material having a redox potential of 4 V or more vs. Li/Li⁺, and also in contact with electron-conducting materials comprising or consisting of elemental carbon (e.g. carbon black, graphite) which are typical electrode additives in electrochemical cells. This is an important advantage over state-of-the-art solid electrolytes which contain sulfur.

It is noted that the solid electrolyte materials prepared according to table 1 of WO 2019/135343 A1 and table 1 of WO 2019/135345 A1 do not fall under formula (I) as defined above.

A solid material according to the first aspect as defined herein may have a composition according to formula (I) wherein M is one or both of Y and Er, preferably Y (yttrium).

A solid material according to the first aspect as defined herein may have a composition according to formula (I) wherein X is one or more halides selected from the group consisting of Cl, Br and I, preferably Cl.

More specifically, a solid material according to the first aspect as defined herein may have a composition according to formula (I) wherein M is one or both of Y and Er, and X is one or more halides selected from the group consisting of Cl, Br and I. Further specifically, a solid material according to the first aspect as defined herein may have a composition according to formula (I) wherein M is Y and X is Cl.

A solid material according to the first aspect as defined herein may have a composition according to formula (I) wherein 0.15≤x≤0.42, preferably 0.18≤x≤0.4, more preferably 0.2≤x≤0.4 resp. 0.18≤x≤0.38, most preferably 0.2≤x≤0.38.

A solid material according to the first aspect as defined herein may have a composition according to formula (I) wherein 5.85≤y≤6.15, more preferably 5.9≤y≤6.1 resp. 5.95≤y≤6.15, most preferably 5.95≤y≤6.1.

More specifically, a solid material according to the first aspect as defined herein may have a composition according to formula (I) wherein 0.15≤x≤0.42, preferably 0.18≤x≤0.4, more preferably 0.2≤x≤0.4 resp. 0.18≤x≤0.38, most preferably 0.2≤x≤0.38, and 5.85≤y≤6.15, more preferably 5.9≤y≤6.1 resp. 5.95≤y≤6.15, most preferably 5.95≤y≤6.1.

Further specifically, a solid material according to the first aspect as defined herein may have a composition according to formula (I) wherein
M is one or both of Y and Er; and
X is one or more halides selected from the group consisting of Cl, Br and I; and
0.15≤x≤0.42, preferably 0.18≤x≤0.4, more preferably 0.2≤x≤0.4 resp. 0.18≤x≤0.38, most preferably 0.25≤x≤0.38, and
5.85≤y≤6.15, more preferably 5.9≤y≤6.1 resp. 5.95≤y≤6.15, most preferably 5.95≤y≤6.1.

In certain cases, a solid material according to the first aspect as defined herein may be crystalline as detectable by the X-ray diffraction technique. A solid material is referred to as crystalline when it exhibits a long range order that is characteristic of a crystal, as indicated by the presence of clearly defined reflections in its X-ray diffraction pattern. In this context, a reflection is considered as clearly defined if its intensity is more than 10% above the background.

A crystalline solid material according to the first aspect as defined herein may comprise one or more crystalline phases having orthorhombic structures in space group Pnma, distinct from Li₃ErCl₆ which has a trigonal structure in the space group P-3m1.

A crystalline solid material according to the first aspect as defined herein may be accompanied by secondary phases and/or impurity phases having a composition not according to general formula (I) as defined above. In such case, the volume fraction of the phase formed of the crystalline solid material having a composition according to general formula (I) may be 60% or more, sometimes 80% or more, preferably 90% or more, most preferably 95% or more, based on the total volume of the solid material according to the first aspect as defined herein and all secondary phases and impurity phases.

If present, the secondary phases and impurity phases mainly consist of the precursors used for preparing the solid material, e.g. LiX (wherein X is as defined above), and sometimes impurity phases which may originate from impurities of the precursors. For details of preparing a solid material according to the first aspect of this disclosure, see the information provided below in the context of the third aspect of this disclosure.

In certain cases, a solid material according to the first aspect as defined herein is in the form of a polycrystalline powder, or in the form of single crystals.

In certain cases, a solid material according to the first aspect as defined herein is glassy, i.e. amorphous. A solid material is referred to as amorphous when it lacks the long range order that is characteristic of a crystal, as indicated by the absence of clearly defined reflections in its X-ray diffraction pattern. In this context, a reflection is considered as clearly defined if its intensity is more than 10% above the background.

In certain cases, a solid material according to the first aspect as defined herein is glass-ceramics, i.e. a polycrystalline solid having at least 30% by volume of a glassy phase.

A solid material according to the first aspect as defined herein may have an ionic conductivity of 0.1 mS/cm or more, preferably 1 mS/cm or more, in each case at a temperature of 25° C. The ionic conductivity is determined in the usual manner known in the field of solid state battery materials development by means of electrochemical impedance spectroscopy (for details see examples section below).

At the same time, a solid material according to the first aspect as defined herein may have an almost negligible electronic conductivity. More specifically, the electronic conductivity may be at least 3 orders of magnitude lower than the ionic conductivity, preferably at least 5 orders of magnitude lower than the ionic conductivity. In certain cases, a solid material according to the first aspect as defined herein exhibits an electronic conductivity of 10⁻¹⁰ S/cm or less. The electronic conductivity is determined in the usual manner known in the field of battery materials development by means of direct-current (DC) polarization measurements at different voltages.

A first group of solid materials according to the first aspect as defined herein has a composition according to formula (I) wherein M and X are as defined above; and M′ is one or more of Ti, Zr and Hf; and 0.12≤x≤0.42, preferably 0.2≤x≤0.4. Since in a solid material of said first group M′ is a four-valent metal, n is 1. Thus, a solid material of said first group has a composition according to formula (Ia)

Li₃₋ₓM₁₋ₓM′ₓX_{y} (Ia)

wherein
M is one or more selected from the group consisting of Sc, In, Lu, La, Er, Y and Ho;
M′ is one or more selected from the group consisting of Ti, Zr, and Hf;
X is one or more selected from the group consisting of halides and pseudohalides;
0.12≤x≤0.42;
5.85≤y≤6.2.

A solid material of the above-defined first group may have a composition according to formula (Ia) wherein M is one or both of Y and Er, preferably Y.

A solid material of the above-defined first group may have a composition according to formula (Ia) wherein X is one or more halides selected from the group consisting of Cl, Br and I, preferably Cl.

More specifically, a solid material of the above-defined first group may have a composition according to formula (Ia) wherein M is one or both of Y and Er, and X is one or more halides selected from the group consisting of Cl, Br and I. Further specifically, a solid material of the above-defined first group may have a composition according to formula (Ia) wherein M is Y and X is Cl.

A solid material of the above-defined first group may have a composition according to formula (Ia) wherein M′ is Zr. More specifically, a solid material of the above-defined first group may have a composition according to formula (Ia) wherein M is one or both of Y and Er, M′ is Zr and X is one or more halides selected from the group consisting of Cl, Br and I.

A solid material of the above-defined first group may have a composition according to formula (Ia) wherein 0.15≤x≤0.42, preferably 0.18≤x≤0.4, more preferably 0.2≤x≤0.4 resp. 0.18≤x≤0.38, most preferably 0.2≤x≤0.38.

A solid material of the above-defined first group may have a composition according to formula (Ia) wherein 5.85≤y≤6.15, more preferably 5.9≤y≤6.1 resp. 5.95≤y≤6.15, most preferably 5.95≤y≤6.1.

More specifically, a solid material of the above-defined first group may have a composition according to formula (Ia) wherein 0.15≤x≤0.42, preferably 0.18≤x≤0.4, more preferably 0.2≤x≤0.4 resp. 0.18≤x≤0.38, most preferably 0.2≤x≤0.38, and 5.85≤y≤6.15, more preferably 5.9≤y≤6.1 resp. 5.95≤y≤6.15, most preferably 5.95≤y≤6.1.

Specific solid materials of the above-defined first group may have a composition according to formula (Ia) wherein M is one or both of Y and Er, and M′ is Zr, and X is Cl.

In certain cases, M is Y, M′ is Zr, and X is Cl.

In certain other cases, M is Er, M′ is Zr, and X is Cl.

While Li₃ErCl₆ has a trigonal symmetry (space group: P-3m1), solid materials according to formula (Ia) wherein M is Er and M′ is Zr and x is up to about 0.2 exhibit a crystalline phase which is isostructural to Li₃LuCl₆ and Li₃YbCl₆ which crystallize in an orthorhombic symmetry (Pnma space group). As more Er³⁺ ions are substituted by Zr⁴⁺ ions (0.2<x≤0.3) a second crystalline phase is formed which has a different orthorhombic symmetry (Pnma space group) which exhibits a distinctly different and unique XRD pattern (see examples section). When x>0.3 said second crystalline phase which has a different orthorhombic symmetry (Pnma space group) is mainly present.

Solid materials according to formula (Ia) wherein M is Y and M′ is Zr and x is up to about 0.2 exhibit a crystalline phase which is isostructural to Li₃LuCl₆ and Li₃YbCl₆ which crystallize in an orthorhombic symmetry (Pnma space group). Similar to solid materials according to formula (Ia) wherein M is Er, as more Y³⁺ ions are substituted by Zr⁴⁺ ions (0.2<x≤0.3) a second crystalline phase is formed which has a different orthorhombic symmetry (Pnma space group) which exhibits a distinctly different and unique XRD pattern (see examples section). When x>0.3 said second crystalline phase which has a different orthorhombic symmetry (Pnma space group) is mainly present.

Without wishing to be bound by any theory it is presently assumed that said second crystalline phase which has a different orthorhombic symmetry (Pnma space group) provides favorable pathways for lithium ion conductivity.

Examples of solid materials of the above-defined first group have a composition according to formula (Ia) wherein M is Y, M′ is Zr, X is Cl and x is in the range of from 0.2 to 0.4, e.g. 0.2, 0.25, 0.3, 0.367 or 0.4. Further examples of solid materials of the above-defined first group have a composition according to formula (Ia) wherein M is Er, M′ is Zr, X is Cl and x is in the range of from 0.2 to 0.4, e.g. 0.2, 0.25, 0.3, 0.367 or 0.4. Said exemplary solid materials have an ionic conductivity of 0.1 mS/cm or more, preferably 1 mS/cm or more, in each case at a temperature of 25° C.

A second group of solid materials according to the first aspect as defined herein has a composition according to formula (I) wherein M and X are as defined above; and M′ is one or both of Nb and Ta; and 0.12≤x≤0.42, preferably 0.2≤x≤0.4. Since in a solid material of said second group M′ is a five-valent metal, n is 2. Thus, a solid material of said second group has a composition according to formula (Ib)

Li₃₋₂ₓM₁₋ₓM′ₓX_{y} (Ib)

wherein
M is one or more selected from the group consisting of Sc, In, Lu, La, Er, Y and Ho;
M′ is one or both selected from the group consisting of Nb and Ta;
X is one or more selected from the group consisting of halides and pseudohalides;
0.12≤x≤0.42;
5.8≤y≤6.2.

A solid material of the above-defined second group may have a composition according to formula (Ib) wherein M is one or both of Y and Er, preferably Y.

A solid material of the above-defined second group may have a composition according to formula (Ib) wherein X is one or more halides selected from the group consisting of Cl, Br and I, preferably Cl.

More specifically, a solid material of the above-defined second group may have a composition according to formula (Ib) wherein M is one or both of Y and Er, X is one or more halides selected from the group consisting of Cl, Br and I. Further specifically, a solid material of the above-defined second group may have a composition according to formula (Ib) wherein M is Y and X is Cl.

A solid material of the above-defined second group may have a composition according to formula (Ib) wherein 0.15≤x≤0.4, more preferably 0.15≤x≤0.35.

A solid material of the above-defined second group may have a composition according to formula (Ib) wherein 5.85≤y≤6.15, more preferably 5.9≤y≤6.1 resp. 5.95≤y≤6.15, most preferably 5.95≤y≤6.1.

More specifically, a solid material of the above-defined second group may have a composition according to formula (Ib) wherein 0.15≤x≤0.4, more preferably 0.15≤x≤0.35, and 5.85≤y≤6.15, more preferably 5.9≤y≤6.1 resp. 5.95≤y≤6.15, most preferably 5.95≤y≤6.1.

Specific solid materials of the above-defined second group may have a composition according to formula (Ib) wherein M is one or both of Y and Er, and M′ is one or both of Nb and Ta, and X is Cl.

In certain cases, M is Y, M′ is Nb or Ta, and X is Cl.

In certain other cases, M is Er, M′ is Nb or Ta, and X is Cl.

Preferred solid materials according to the first aspect as defined herein are those having one or more of the specific and preferred features disclosed above.

According to a second aspect, there is provided a composite comprising
a solid material according to the above-defined first aspect
and a cathode active material.

In the context of the present disclosure, the electrode of an electrochemical cell where during discharging of the cell a net positive charge occurs is called the cathode, and the component of the cathode by reduction of which said net positive charge is generated is referred to as a “cathode active material”.

In the above defined composite, the solid material according to the above-defined first aspect acts as a solid electrolyte which is conductive for Li⁺ ions (lithium ions).

Preferred cathode active materials are those having a redox potential of 4 V or more vs. Li/Li⁺ (cathode active material of the “4 V class”), which enable obtaining a high cell voltage. A couple of such cathode active materials is known in the art.

Suitable cathode active materials are oxides comprising lithium, and one or more members of the group consisting of nickel, cobalt and manganese.

Certain suitable cathode active materials are oxides comprising
lithium,
nickel and
one or both members of the group consisting of cobalt and manganese.

Exemplary cathode active materials which may be used in combination with the solid material according to the above-defined first aspect are compounds of formula (II):

Li₁₊ₜA₁₋ₜO₂ (II),

wherein
A comprises nickel
and one or both members of the group consisting of cobalt and manganese, and optionally
   one or more further transition metals not selected from the group consisting of nickel, cobalt and manganese, wherein said further transition metals are preferably selected from the group consisting of molybdenum, titanium, tungsten, zirconium,
   one or more elements selected from the group consisting of aluminum, barium, boron and magnesium,
wherein at least 50 mole-% of the transition metal of A is nickel;
   t is a number in the range of from −0.05 to 0.2.

Suitable cathode active materials having a composition according to formula (II) are described in a non-prepublished European patent application 19180075.4-1108.

Exemplary cathode active materials of formula (II) which may be used in combination with the solid material according to the above-defined first aspect are Li₁₊ₜ[Ni_{0.85}Co_{0.10}Mn_{0.05}]₁₋ₜO₂, Li₁₊ₜ[Ni_{0.87}Co_{0.05}Mn_{0.08}]₁₋ₜO₂, Li₁₊ₜ[Ni_{0.83}Co_{0.12}Mn_{0.05}]₁₋ₜO₂, Li₁₊ₜ[Ni_{0.6}Co_{0.2}Mn_{0.2}]₁₋ₜO₂, Li₁₊ₜ[Ni_{0.88}Co_{0.08}Al_{0.04}]₁₋ₜO₂, Li₁₊ₜ[Ni_{0.905}Co_{0.0475}Al_{0.0475}]₁₋ₜO₂, and Li₁₊ₜ[Ni_{0.91}Co_{0.045}Al_{0.045}]₁₋ₜO₂, wherein in each case −0.05≤t≤0.2.

Other exemplary cathode active materials which may be used in combination with the solid material according to the above-defined first aspect are LiCoO₂ and LiNi_{0.5}Mn_{1.5}O₄.

In the above defined composite, a cathode active material and a solid material according to the above-defined first aspect may be admixed with each other. More specifically, in a composite according to the second aspect as defined herein, a cathode active material and a solid material according to the above-defined first aspect may be admixed with each other and with one or more binding agents and/or with one or more electron-conducting materials. Typical electron-conducting materials are those comprising or consisting of elemental carbon, e.g. carbon black and graphite. Typical binding agents are poly(vinylidenefluroride) (PVDF), styrene-butadiene rubber (SBR), polyisobutene, poly(ethylene vinyl acetate), poly(acrylonitrile butadiene).

A composite as defined above may be used for preparing a cathode for an electrochemical cell.

A composite as defined above may be used in a cathode for an electrochemical cell.

Due to its superior electrochemical oxidative stability, a solid material according to the first aspect of the present disclosure (as defined above) may be applied as a solid electrolyte in direct contact with a cathode active material having a redox potential of 4 V or more, preferably of 4.5 V or more vs. Li/Li⁺. Substantially no oxidative side reaction of the solid electrolyte occurs during discharging of the cathode active material.

This is an important advantage because it may become possible to apply electrochemical cell configurations wherein the cathode active material is in direct contact with a solid electrolyte in the form of a solid material according to the above-defined first aspect so that a protection layer between the cathode active material and the solid electrolyte can be omitted. Thus, complexity of the configuration and of the manufacturing process of electrochemical cells is reduced, and the additional ohmic resistance inevitably introduced by a protection layer is omitted.

Preferred composites according to the second aspect as defined herein are those having one or more of the specific and preferred features disclosed above.

According to a third aspect, there is provided a process for obtaining a solid material according to the above-defined first aspect. Said process comprises the following process steps:
a) providing a reaction mixture comprising the precursors
   (1) one or more compounds selected from the group consisting of halides and pseudohalides of lithium; and
   (2) one or more compounds selected from the group consisting of halides and pseudohalides of elements M selected from the group consisting of Sc, In, Lu, La, Er, Y and Ho; and
   (3) one or more compounds selected from the group consisting of halides and pseudohalides of elements M′ selected from the group consisting of Ti, Zr, Hf, Nb and Ta;
   wherein in said reaction mixture the molar ratio of Li, M, M′, halide ions and pseudohalide ions matches general formula (I);
b) reacting the reaction mixture to obtain a solid material having a composition according to general formula (I).

In step a) of the process according to the above-defined third aspect, a reaction mixture comprising precursors for the reaction product to be formed in step b) is provided. Said precursors are
(1) one or more compounds LiX; and
(2) one or more compounds MX₃, wherein M is one or more selected from the group consisting of Sc, In, Lu, La, Er, Y and Ho; and
(3) one or more from the group consisting of
   compounds M′X₄ wherein M′ is one or more of Ti, Zr and Hf; and
   compounds M′X₅ wherein M′ is one or both of Nb and Ta;
      wherein in each of precursors (1) to (3), independently from the other precursors, X is one or more selected from the group consisting of halides and pseudohalides;
      wherein the molar ratio of Li, M, M′ and X matches general formula (I).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain cases, in precursor (2) M is one or both of Y and Er, preferably Y.

In specific cases, in each of precursors (1) to (3), independently from the other precursors, X is one or more selected from the group consisting of Cl, Br and I, and in precursor (2) M is one or both of Y and Er. Further specifically, in each of precursors (1) to (3) X is Cl, and in precursor (2) M is Y.

In certain processes according to the above-defined third aspect, the precursor (3) is one or more compounds from the group consisting of compounds M′X₄ wherein M′ is one or more of Ti, Zr and Hf, and X is as defined above. Such processes are suitable for preparing solid materials having a composition according to general formula (Ia) as defined above.

Thus, suitable precursors for a solid material having a composition according to general formula (Ia) are
(1) one or more compounds LiX; and
(2) one or more compounds MX₃ wherein M is one or more selected from the group consisting of Sc, In, Y, La, Er, Y and Ho; and
(3) one or more compounds from the group consisting of compounds M′X₄ wherein M′ is one or more of Ti, Zr and Hf, preferably Zr;
   wherein in each of precursors (1) to (3), independently from the other precursors, X is one or more selected from the group consisting of halides and pseudohalides;
   wherein the molar ratio of Li, M, M′ and X matches general formula (Ia).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain cases, in precursor (2) M is one or both of Y and Er, preferably Y.

In specific cases, in each of precursors (1) to (3), independently from the other precursors, X is one or more selected from the group consisting of Cl, Br and I, and in precursor (2) M is one or both of Y and Er. Further specifically, in each of precursors (1) to (3) X is Cl, and in precursor (2) M is Y.

In certain cases, in precursor (3) M′ is Zr.

In specific cases, in each of precursors (1) to (3), independently from the other precursors, X is one or more selected from the group consisting of Cl, Br and I, in precursor (2) M is one or both of Y and Er, and in precursor (3) M′ is Zr. Further specifically, in each of precursors (1) to (3), X is Cl, in precursor (2) M is Y and in precursor (3) M′ is Zr.

In certain processes according to the above-defined third aspect, the precursor (3) is one or more compounds from the group consisting of compounds M′X₅ wherein M′ is one or both of Nb and Ta, and X is as defined above. Such processes are suitable for preparing solid materials having a composition according to general formula (Ib) as defined above.

Thus, suitable precursors for a solid material having a composition according to general formula (Ib) are
(1) one or more compounds LiX; and
(2) one or more compounds MX₃ wherein M is one or more selected from the group consisting of Sc, In, Lu, La, Er, Y and Ho; and
(3) one or more compounds from the group consisting of compounds M′X₅ wherein M′ is one or both of Nb and Ta;
   wherein in each of precursors (1) to (3), independently from the other precursors, X is one or more selected from the group consisting of halides and pseudohalides;
   wherein the molar ratio of Li, M, M′ and X matches general formula (Ib).

Preferably, the reaction mixture consists of the above-defined precursors (1), (2) and (3).

In certain cases, in each of precursors (1) to (3), independently from the other precursors, X is one or more selected from the group consisting of Cl, Br and I. Preferably in each of precursors (1) to (3) X is the same, preferably Cl.

In certain cases, in precursor (2) M is one or both of Y and Er, preferably Y.

In specific cases, in each of precursors (1) to (3), independently from the other precursors, X is one or more selected from the group consisting of Cl, Br and I, and in precursor (2) M is one or both of Y and Er. Further specifically, in each of precursors (1) to (3) X is Cl, and in precursor (2) M is Y.

In step a) the reaction mixture may be obtained by mixing the precursors. Mixing the precursors may be performed by means of grinding the precursors together. Grinding can be done using any suitable means.

The reaction mixture which is prepared or provided in step a) may be formed into pellets, which are heat-treated in step b). Then, a solid material in the form of pellets or chunks is obtained, which may be ground into powder for further processing.

It is useful that in step a) any handling is performed under a protective gas atmosphere.

In step b) of the process according to the above-defined third aspect, the reaction mixture is allowed to react so that a solid material having a composition according to general formula (I) is obtained. In other words, in step b) the precursors in the reaction mixture react with each other to obtain a solid material having a composition according to general formula (I).

The reaction mixture prepared in process step a) may be heat-treated in step b) to enable the reaction of the precursors. Said reaction is considered to be substantially a solid state reaction, i.e. it occurs with the reaction mixture in the solid state.

Heat-treating may be performed in a closed vessel. The closed vessel may be a sealed quartz tube or any other type of container which is capable of withstanding the temperature of the thermal treatment and is not subject to reaction with any of the precursors, such as a glassy carbon crucible or a tantalum crucible.

In step b) the reaction mixture may be heat-treated in a temperature range of from 150° C. to 850° C. for a total duration of 1 hour to 24 hours so that a reaction product is formed. More specifically, in step b) the reaction mixture may be heat-treated in a temperature range of 350° C. to 650° C. for a total duration of 5 hours to 15 hours.

When the duration of the heat treatment of step b) is completed, the formed reaction product is allowed to cool down. Thus, a solid material having a composition according to general formula (I) is obtained. Cooling of the reaction product is preferably performed using a cooling rate of 1 to 10° C. per minute.

A specific process according to the third aspect as described herein comprising the steps
a) preparing or providing a solid reaction mixture comprising the precursors (1), (2) and (3), preferably a reaction mixture consisting of the precursors (1), (2) and (3)
b) heat-treating the reaction mixture in a temperature range of 150° C. to 850° C. for a total duration of 1 hour to 24 hours so that a reaction product is formed, and cooling the reaction product so that a solid material having a composition according to general formula (I) is obtained.

Preferred processes according to the third aspect as defined herein are those having one or more of the specific features disclosed above.

A solid material according to the above-defined first aspect resp. obtained by the process according to the above-defined third aspect can be used as a solid electrolyte for an electrochemical cell. Herein the solid electrolyte may form a component of a solid structure for an electrochemical cell, wherein said solid structure is selected from the group consisting of cathode, anode and separator. Accordingly, a solid material according to the above-defined first aspect resp. obtained by the process according to the above-defined third aspect can be used alone or in combination with additional components for producing a solid structure for an electrochemical cell, such as a cathode, an anode or a separator. The substantial absence of undesirable decomposition of the solid electrolyte may remarkably improve the cell performance.

Thus, the present disclosure further provides the use of a solid material according to the above-defined first aspect resp. obtained by the process according to the above-defined third aspect as a solid electrolyte for an electrochemical cell. More specifically, the present disclosure further provides the use of a solid material according to the above-defined first aspect resp. obtained by the process according to the above-defined third aspect as a component of a solid structure for an electrochemical cell, wherein said solid structure is selected from the group consisting of cathode, anode and separator.

In the context of the present disclosure, the electrode of an electrochemical cell where during discharging a net negative charge occurs is called the anode and the electrode of an electrochemical cell where during discharging a net positive charge occurs is called the cathode. The separator electronically separates a cathode and an anode from each other in an electrochemical cell.

The cathode of an all-solid-state electrochemical cell usually comprises a solid electrolyte as a further component beside a cathode active material. Also the anode of an all-solid-state electrochemical cell usually comprises a solid electrolyte as a further component beside an anode active material. Said solid electrolyte may be a solid material according to the above-defined first aspect resp. obtained by the process according to the above-defined third aspect.

The form of the solid structure for an electrochemical cell, in particular for an all-solid-state lithium battery, depends in particular on the form of the produced electrochemical cell itself.

The present disclosure further provides a solid structure for an electrochemical cell, wherein the solid structure is selected from the group consisting of cathode, anode and separator, wherein the solid structure comprises a solid material according to the above-defined first aspect resp. obtained by the process according to the above-defined third aspect. More specifically, the solid structure for an electrochemical cell may be a cathode comprising a composite according to the above-defined second aspect.

The present disclosure further provides an electrochemical cell comprising a solid material according to the above-defined first aspect resp. obtained by the process according to the above-defined third aspect. In said electrochemical cell, the solid material according to the above-defined first aspect resp. obtained by the process according to the above-defined third aspect may form a component of one or more solid structures selected from the group consisting of cathode, anode and separator. More specifically, there is provided an electrochemical cell as defined above wherein in certain preferred cases a solid material according to the above-defined first aspect resp. obtained by the process according to the above-defined third aspect may be in direct contact with a cathode active material having a redox potential of 4 V or more, preferably of 4.5 V or more vs. Li/Li⁺.

The above-defined electrochemical cell may be a rechargeable electrochemical cell comprising the following constituents
α) at least one anode,
β) at least one cathode,
γ) at least one separator,
   wherein at least one of the three constituents is a solid structure (selected from the group consisting of cathode, anode and separator) comprising a solid material according to the above-defined first aspect resp. obtained by the process according to the above-defined third aspect.

Suitable cathode active materials (electrochemically active cathode materials) and suitable anode active materials (electrochemically active anode materials) are known in the art. Exemplary cathode active materials are disclosed above in the context of the second aspect. In an electrochemical cell as described above the anode a) may comprise graphitic carbon, metallic lithium or a metal alloy comprising lithium as the anode active material. Electrochemical cells as described above may be alkali metal containing cells, especially lithium-ion containing cells. In lithium-ion containing cells, the charge transport is effected by Li⁺ ions.

The electrochemical cell may have a disc-like or a prismatic shape. The electrochemical cell can include a housing that can be made of steel or aluminum.

A plurality of electrochemical cells as described above may be combined to an all-solid-state battery, which has both solid electrodes and solid electrolytes. A further aspect of the present disclosure refers to batteries, more specifically to an alkali metal ion battery, in particular to a lithium ion battery comprising at least one electrochemical cell as described above, for example two or more electrochemical cells as described above. Electrochemical cells as described above can be combined with one another in alkali metal ion batteries, for example in series connection or in parallel connection. Series connection is preferred.

The electrochemical cells resp. batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present disclosure is the use of the electrochemical cell as described above in motor vehicles, bicycles operated by electric motor, robots, aircraft (for example unmanned aerial vehicles including drones), ships or stationary energy stores.

The present disclosure further provides a device comprising at least one inventive electrochemical cell as described above. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### EXAMPLES

1. Preparation of Solid Materials

Reaction mixtures consisting of the precursors

### (1) LiCl

(2) YCl₃ resp. ErCl₃

### (3) ZrCl₄

in the proportions to obtain the compositions indicated in table 1 resp. 2 were prepared by uniformly mixing the precursors (1), (2) and (3) using a mortar and pestle in an argon filled glovebox (step a)). Each reaction mixture was heated-treated at 450° C. in a vacuum sealed quartz tube for 12 hours to react the reaction mixture (step b)), and in each case the obtained reaction product was cooled at a rate of 2 K/min. to obtain a solid material in the form of a powder having a composition according to general formula (I) as indicated in table 1 resp. 2.

Materials A1, A2, A7 (cf. table 1) and B1, B2, B8 (cf. table 2) are not according to the invention and were prepared and analysed for comparison.

2. Structure Analysis

Powder X-ray diffraction (XRD) measurements of the solid materials obtained as described above were conducted at room temperature using a PANalytical Empyrean diffractometer with Cu-Kα radiation equipped with a PIXcel bidimensional detector. XRD patterns for phase identification were obtained in Debye-Scherrer geometry, with samples sealed in sealed in 0.3 mm glass capillaries under argon.

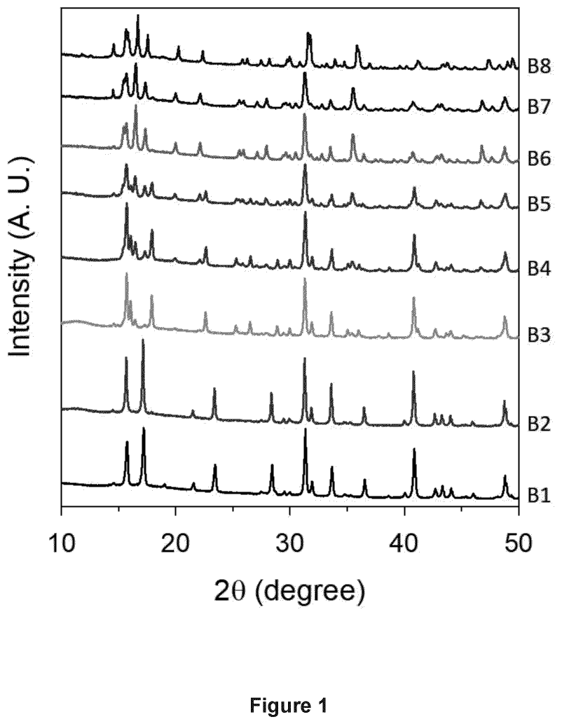

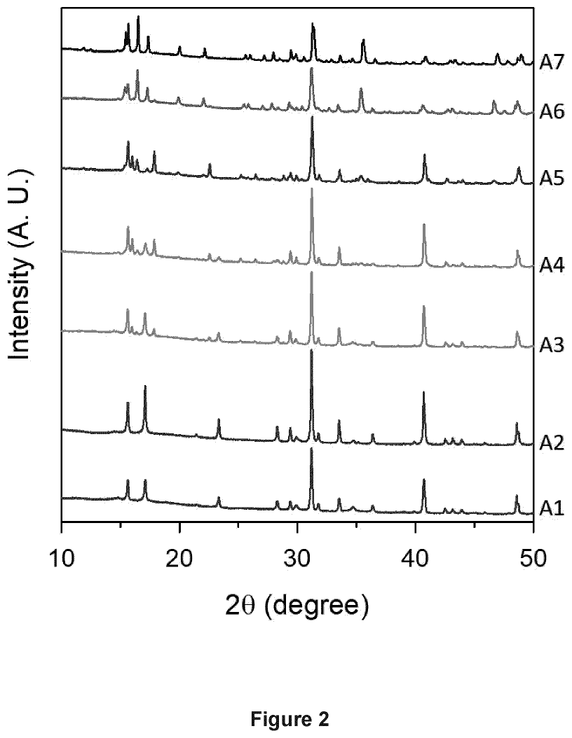

The solid materials obtained as described above were polycrystalline and had little to no impurities as can be derived from the XRD patterns shown in FIGS. 1 and 2.

FIG. 1 shows the X-ray diffraction (XRD) patterns of Li₃₋ₓZrₓEr₁₋ₓCl₆ materials B1-B8 over the range from x=0 to x=0.8 (cf. table 2 below). The XRD pattern of Li₃ErCl₆ (x=0, material B1) matches well with its reported trigonal structure (space group: P-3m1, see e.g. US 2009/0088995 A1). This structure (denoted as phase 1) is preserved at x=0.1 (material B2, not according to the invention). When more Zr⁴⁺ ions are introduced, a new XRD pattern is obtained at x=0.2 (material B3), indicating formation of a new phase having orthorhombic structure which is denoted as phase II. Phase II is isostructural to Li₃LuCl₆ and Li₃YbCl₆ (both crystallizing in the Pnma space group). The weight average of the crystal ionic radii of the transition metal ions Er³⁺ and Zr⁴⁺ of Li_{2.8}Zr_{0.2}Er_{0.8}Cl₆ is r=99.6 pm which is close to the crystal ionic radius of Lu³⁺ (r=100.1 pm) and of Yb³⁺ (r=100.8 pm), which is likely responsible for formation of a phase II which is isostructural to Li₃LuCl₆ and Li₃YbCl₆. As more Er³⁺ ions are substituted by Zr⁴⁺ ions, another phase having orthorhombic structure in the Pnma space group (phase III) is observed when 0.367≤x≤0.4 (materials B6 and B7) that exhibits a distinctly different and unique XRD pattern, following an excursion in a short two-phase region (0.2<x≤0.3, materials B4 and B5) where phase II and phase Ill are present.

FIG. 2 shows the X-ray diffraction (XRD) patterns of Li₃₋ₓZrₓY₁₋ₓCl₆ materials A1-A7 over the range from x=0 to x=0.6 (cf. table 1 below). The XRD pattern of Li₃YCl₆ (x=0, material A1) indicates a trigonal structure (space group: P-3m1). When x is in the range up to about 0.2 (materials A2 and A3) the XRD patterns indicate an orthorhombic structure (Pnma space group) almost identical to phase II of the Li₃₋ₓZrₓEr₁₋ₓCl₆ materials described above. As more Y³⁺ ions are substituted by Zr⁴⁺ ions, another phase having orthorhombic structure in the Pnma space group almost identical to phase III of the Li₃₋ₓZrₓEr₁₋ₓCl₆ materials described above is observed when 0.367≤x≤0.6 (materials A6 and A7), following an excursion in a short two-phase region (0.2<x≤0.3, materials A4 and A5) where both orthorhombic phases are present.

3. Ionic Conductivity

Ionic conductivities were measured by electrochemical impedance spectroscopy (EIS) at different temperatures from 25° C. to 100° C. Typically, 150-200 mg of powder of the material was placed between two stainless steel rods and pressed into a 10 mm diameter pellet by a hydraulic press at 3 metric tons for 3 min in an Argon-filled glovebox. EIS experiments were performed with 100 mV amplitude within a frequency range of 1 MHz-10 mHz using a VMP3 potentiostat/galvanostat (Bio-Logic). The solid electrolyte (SE) pellet was placed between electronically blocking titanium electrodes (cell configuration Ti|SE|Ti).

The lithium ion conductivity measured at 25° C. and the activation energy determined in the usual manner from the conductivity as a function of the temperature according to the Arrhenius equation

σ_{T}=A_{T} exp(−Eₐ/k_{B}T)

(where σ_{T} is the ionic conductivity at the temperature T, T is the temperature in K, A_{T} the pre-exponential factor, Eₐ the activation energy and k_{B} the Boltzmann constant) of all materials is given in tables 1 and 2 below.

TABLE 1

| | | Ionic conductivity | Activation |
|---|---|---|---|
| Material | x in Li₃₋ₓY₁₋ₓZrₓCl₆ | at 25° C. (S/cm) | Energy (eV) |
| A1 | 0 | 6.7 × 10⁻⁵ | 0.50 |
| A2 | 0.100 | 3.2 × 10⁻⁴ | 0.43 |
| A3 | 0.200 | 9.7 × 10⁻⁴ | 0.37 |
| A4 | 0.250 | 1.0 × 10⁻³ | 0.37 |
| A5 | 0.300 | 1.2 × 10⁻³ | 0.36 |
| A6 | 0.367 | 1.3 × 10⁻³ | 0.34 |
| A7 | 0.600 | 9.6 × 10⁻⁴ | 0.34 |

TABLE 2

| | | Ionic conductivity | Activation |
|---|---|---|---|
| Material | x in Li₃₋ₓEr₁₋ₓZrₓCl₆ | at 25° C. (S/cm) | Energy (eV) |
| B1 | 0 | 8.7 × 10⁻⁵ | 0.52 |
| B2 | 0.100 | 3.6 × 10⁻⁴ | 0.44 |
| B3 | 0.200 | 7.7 × 10⁻⁴ | 0.39 |
| B4 | 0.250 | 7.9 × 10⁻⁴ | 0.39 |
| B5 | 0.300 | 1.1 × 10⁻³ | 0.38 |
| B6 | 0.367 | 1.1 × 10⁻³ | 0.35 |
| B7 | 0.400 | 1.0 × 10⁻³ | 0.36 |
| B8 | 0.800 | 4.1 × 10⁻⁴ | 0.38 |

Tables 1 and 2 show that the ionic conductivity increases when Y resp. Er is partly substituted by Zr while after passing a maximum of the ionic conductivity further substitution of Y resp. Er by Zr does not result in a further increase of the ionic conductivity.

4. Electrochemical Tests

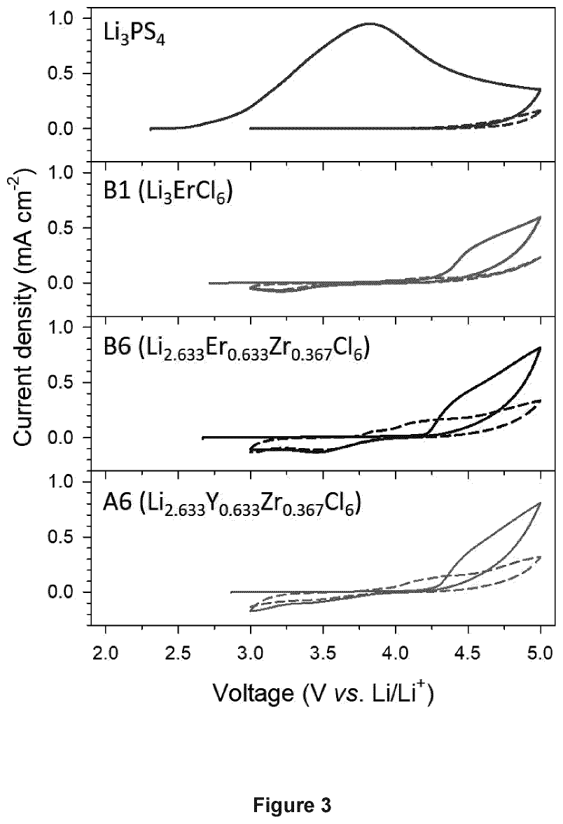

Cyclic voltammograms of all-solid-state cells having the configuration (SE/carbon black mixture)|Li₃PS₄|Li₁₁Sn₆ are shown in FIG. 3. A mixture of a solid electrolyte (SE) and carbon black (weight ratio 95:5) was the working electrode, wherein the solid electrolyte SE is either Li₃PS₄ (not according to the invention) or Li₃ErCl₆ (material B1 not according to the invention) resp. Li_{2.633}Er_{0.633}Zr_{0.367}Cl₆ (material B6 according to the invention) or Li_{2.633}Y_{0.633}Zr_{0.367}Cl₆ (material A6 according to the invention). L₁₁Sn₆ (+0.49 V vs. Li/Li⁺) was used as the counter electrode in each case. The scan rate was 1 mV s⁻¹.

When the solid electrolyte in the working electrode is Li₃PS₄ (not according to the invention), in the first scan (solid line) an oxidation current of Li₃PS₄ arises after 2.5 V (vs. Li/Li⁺) and continues to increase up to 3.8 V. This oxidation current is assigned to the oxidation of sulfide ions. The following scan (dashed line) exhibits a lower oxidation current, reflecting the ion-blocking nature of resulting carbon/Li₃PS₄ interface.

In contrast, no oxidation current is observed before 4.3 V when the solid electrolyte in the working electrode is Li₃ErCl₆ (material B1 not according to the invention) resp. Li₂₋₆₃₃Er_{0.633}Zr_{0.367}Cl₆ (material B6 according to the invention) or Li_{2.633}Y_{0.633}Zr_{0.367}Cl₆ (material A6 according to the invention). A small redox process above 4.40 V is observed on the first scan (solid line) that decreases substantially on the second scan (dashed line).

The difference in the voltammograms is in accordance with the difference in standard reduction potentials of chlorine (Cl₂, gaseous) (+4.40 V vs. Li/Li⁺) and sulfur (S, solid) (+2.56 V vs. Li/Li⁺). This observation directly visualizes the superior electrochemical oxidation stability of chlorides compared to sulfides.

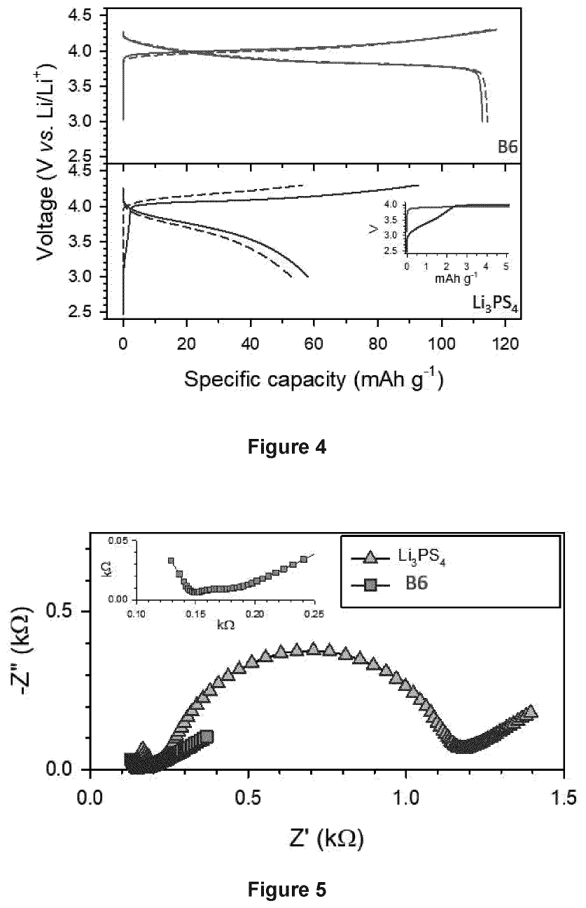

The first (solid lines) and second (dashed lines) charge-discharge profiles (current density 0.1 mA cm⁻²) of all-solid-state cells having the configuration (SE/LiCoO₂ mixture)/Li₃PS₄/Li₁₁Sn₆ are shown in FIG. 4. The inset shows the initial charging behavior. In the cathode, the solid electrolyte SE admixed to the cathode active material LiCoO₂ (weight ratio LiCoO₂:SE of 70:30) is either Li₃PS₄ (not according to the invention) or Li_{2.633}Er_{0.633}Zr_{0.367}Cl₆ (material B6 according to the invention) so that a composite cathode is obtained. In the anode, solid electrolyte Li₃PS₄ powder is admixed to the anode active material Li₁₁Sn₆ (weight ratio Li₃PS₄:Li₁₁Sn₆ of 20:80) in each case to enhance Li⁺ diffusion.

When the cathode contains Li₃PS₄ as the solid electrolyte, the discharge capacity was only 93 mAh g⁻¹, and poor initial coulombic efficiency of 62.7% was obtained. A gradual increase of the voltage that is attributed to sulfide oxidation was observed at the early stage of charging (FIG. 4, bottom part, and lower graph in the inset).

In contrast, when the cathode contains Li_{2.633}Er_{0.633}Zr_{0.367}Cl₆ as the solid electrolyte, the cell exhibits more than 110 mAh g⁻¹ discharge capacity with high initial coulombic efficiency of 96.4%. No oxidative side reaction occurred prior to Li⁺ de-intercalation from LiCoO₂ when the cathode contains Li_{2.633}Er_{0.633}Zr_{0.367}Cl₆ as the solid electrolyte (FIG. 4, upper part). A steep increase of the voltage occurs during initial discharge (FIG. 4, inset). The absence of undesirable decomposition of the solid electrolyte remarkably improves the cell performance.

A slightly higher capacity was obtained when a composite cathode having a ratio of LiCoO₂:SE of 85:15 instead of 70:30 was used.

A diagnostic electrochemical analysis of the cells having the above-indicated configuration was conducted by using electrochemical impedance spectroscopy (EIS). The Nyquist plots measured after the end of 6th charging process are shown in FIG. 5.

The Nyquist plot in each case exhibits two semi-circles followed by a low-frequency Warburg tail. The semi-circle in the high-frequency region is attributed to the resistance of the solid electrolyte layer, and the semi-circle in the low-frequency region originates from the interfacial charge transport phenomena at the LiCoO₂/solid electrolyte interface in the LiCoO₂/solid electrolyte composite electrode (charge transfer resistance). The charge transfer resistance of the composite electrode LiCoO₂/Li₃PS₄ (˜950Ω) is almost twenty-five fold higher than that of the composite cathode LiCoO₂/Li_{2.633}Er_{0.633}Zr_{0.367}Cl₆ (˜40Ω, see inset of FIG. 5). The high charge transfer resistance of the composite electrode LiCoO₂/Li₃PS₄ may be attributed to oxidative side reactions/decomposition of Li₃PS₄.

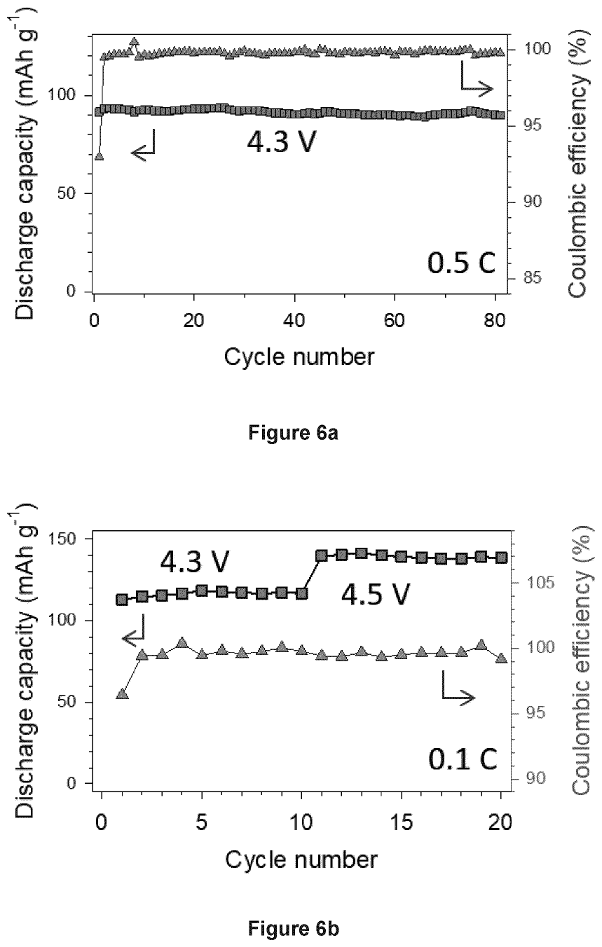

FIG. 6a displays the room temperature cycling performance of the cell using the LiCoO₂/Li_{2.633}Er_{0.633}Zr_{0.367}Cl₆ composite cathode with a current density of 0.1 mA cm⁻², C-rate 0.1 C. The cell exhibits highly reliable cycling performance not only with a 4.3 V cut-off but also with a 4.5 V cut-off in spite of the small oxidation current above 4.4 V observed by cyclic voltammetry on the first sweep (cf. FIG. 3). Highly reliable cycling performance (4.3 V cut-off) was also observed upon cycling with a C-rate of 0.5 C over more than 80 cycles, see FIG. 6b.

1. A solid material having a composition according to general formula (I)
Li_{3-n*x}M₁₋ₓM′ₓX_{y} (I)
wherein
M is Er;
M′ is one or more selected from the group consisting of Ti, Zr, Hf, Nb and Ta;
X is one or more selected from the group consisting of halides and pseudohalides; 0.12≤x≤0.42;
5.8≤y≤6.2;
n is the difference between the valences of M′ and M.

2. The solid material according to claim 1, wherein 5.85≤y≤6.15, preferably 5.9≤y≤6.1.

3. The solid material according to claim 1, wherein
M′ is one or more of Ti, Zr and Hf; and
X is one or more selected from the group consisting of Cl, Br and I; and 0.12≤x≤0.42, preferably 0.2≤x≤0.4.

4. The solid material according to claim 3, wherein
M′ is Zr, and X is Cl.

5. The solid material according to claim 1, wherein
M′ is one or both of Nb and Ta; and
X is one or more selected from the group consisting of Cl, Br and I; and 0.15≤x≤0.35.

6. The solid material according to claim 1, wherein the solid material is
crystalline and has an orthorhombic structure in space group Pnma, or
is a glass, or
is a glass-ceramics.

7. A composite comprising
the solid material according to claim 1, and
a cathode active material, wherein the cathode active material preferably comprises one or more compounds of formula (II):
Li₁₊ₜA₁₋ₜO₂ (II),
wherein
A comprises nickel and one or both members of the group consisting of cobalt and manganese, and optionally
one or more further transition metals not selected from the group consisting of nickel, cobalt and manganese, wherein said further transition metals are preferably selected from the group consisting of molybdenum, titanium, tungsten, zirconium,
one or more elements selected from the group consisting of aluminum, barium, boron and magnesium,
wherein at least 50 mole-% of the transition metal of A is nickel;
t is a number in the range of from −0.05 to 0.2.

8. The composite according to claim 7, wherein the solid material and the cathode active material are admixed with each other.

9. A process for preparing a solid material according to claim 1,
the process comprising
a) providing a reaction mixture comprising the precursors
(1) one or more compounds selected from the group consisting of halides and pseudohalides of lithium; and
(2) one or more compounds selected from the group consisting of halides and pseudohalides of Er; and
(3) one or more compounds selected from the group consisting of halides and pseudohalides of elements M′ selected from the group consisting of Ti, Zr, Hf, Nb and Ta;
wherein in said reaction mixture the molar ratio of Li, M, M′, halides and pseudohalides matches general formula (I);
b) reacting the reaction mixture to obtain a solid material having a composition according to general formula (I).

10. The process according to claim 9, wherein the precursors are
(1) one or more compounds LiX; and
(2) one or more compounds MX₃ wherein M is Er; and
(3) one or more compounds from the group consisting of
compounds M′X₄ wherein M′ is one or more of Ti, Zr and Hf, and
compounds M′X₅ wherein M′ is one or both of Nb and Ta;
wherein in each of precursors (1) to (3), independently from the other precursors, X is one or more selected from the group consisting of Cl, Br and I, preferably Cl;
wherein the molar ratio of Li, M, M′ and X matches general formula (I).

11. The process according to claim 9, further comprising
a) preparing or providing a solid reaction mixture comprising the precursors (1), (2) and (3)
b) heat-treating the reaction mixture in a temperature range of 150° C. to 850° C. for a total duration of 1 hour to 24 hours so that a reaction product is formed, and cooling the reaction product so that a solid material having a composition according to general formula (I) is obtained.

12. A solid structure for an electrochemical cell, wherein the solid structure is selected from the group consisting of cathode, anode and separator, wherein the solid structure for an electrochemical cell comprises the solid material according to claim 1.

13. A solid structure for an electrochemical cell, wherein the solid structure is a cathode, wherein the cathode comprises a composite according to claim 7.

14. The electrochemical cell comprising a solid material according to claim 6.

15. The electrochemical cell according to claim 14, wherein the solid material is a component of a solid structure as defined in claim 12.
